(19) United States
(12) Patent Application Publication
(10) Pub. No.: US 2017/0372135 A1
(43) Pub. Date: Dec. 28, 2017

(54) SYSTEM AND METHOD TO COLLABORATIVELY IDENTIFY PAPER-INTENSIVE PROCESSES

(71) Applicant: Xerox Corporation, Norwalk, CT (US)

(72) Inventors: Jutta Katharina Willamowski, Grenoble (FR); Jerome Pouyadou, Grenoble (FR); Yves Hoppenot, Notre Dame de Message (FR); Matthieu Mazzega, Grenoble (FR); Emmanuel Rado, Grenoble (FR); Asma Bennani, Grenoble (FR); Julien Soler, Grenoble (FR); Michel Langlais, Pont de Claix (FR); Juan-Pablo Suarez, Grenoble (FR)

(73) Assignee: Xerox Corporation, Norwalk, CT (US)

(21) Appl. No.: 15/193,660

(22) Filed: Jun. 27, 2016

(51) Int. Cl. G06K 9/00; G06F 3/12; G06K 9/62

(52) U.S. Cl. CPC G06K 9/00456; G06K 9/6218; G06F 3/1219; G06F 3/1273; G06F 3/1294

(57) ABSTRACT

A computer-implemented method for gathering knowledge within an organization for supporting the preparation, animation, and execution of a collaborative workshop for high speed and efficient document management and labeling. Printed documents are tracked within the system over a specified amount of time to acquire print job information from the jobs printed within an organization. Based upon the documents retrieved, a list of users is determined and invited to review and annotate the list of documents. The list of documents is then narrowed down to an optimized set for ease of labeling and clustering. Provision is made for user-annotation of the classification label associated with the submitted print jobs including a reason for printing the print job. User-annotations are received for at least some of the submitted print jobs. The print jobs may be clustered into clusters based on the print job representations and annotations. A representation of the set of print jobs is generated which represents the agreed upon labels for a set of documents with similar traits in at least one of the clusters, based on the user provided labels.

### BACKGROUND

In many contexts, such as the service industry, work is generally organized into processes that often entail printing documents. There is a growing trend towards replacing printing paper documents with digital counterparts, which may entail use of electronic signatures, email (instead of post mail) and online form filling. There are many reasons for this change, including higher productivity, cost-efficiency, and becoming more environmentally-friendly. Many large organizations are therefore looking for solutions to reduce paper usage and to move from using paper to digital documents. Unfortunately, especially in large organizations, it is often difficult to achieve this goal, because of a lack of information. Those in management, for example, often do not have a detailed understanding of where paper is being used by company employees, in particular, in which tasks or subtasks paper documents are generated, as well as how much paper is used in the process, in terms of the volume of paper being used in each of these tasks. Nor is there a good understanding of the reasons why paper is used for these tasks, i.e., what are the barriers that prevent using digital versions instead of paper documents within these tasks.

Having answers to these questions would help organizations to select which processes/tasks could be modified to facilitate moving them from paper to digital. However, without a good understanding of the paper consumption of the various tasks, and the reasons for printing documents, it is difficult to focus these efforts on the processes where changes would be the most effective.

It is now becoming important to not only looking at ways to facilitate printing inside a client corporation, but as well at optimizing printing by replacing inefficient paper workflows by more efficient electronic ones. The reasons for printing documents are often task dependent. Some common reasons involve requiring signatures, archiving, transitions between different computer systems, crossing organizational barriers, and so forth. However, there may be other reasons that have not been identified by the organization. To move from paper to digital, appropriate solutions may need to be implemented to replace the functions previously provided through generating paper documents, such as digital archiving, digital signatures, and the like. However, for some tasks, paper may afford benefits that digital documents do not provide. Paper is, for example, easy portable (e.g., when traveling), easy to read and annotate, and easy to hand over to another person. Employees could be provided with portable devices, such as eReaders, to address some of these issues, but this solution may not be cost-effective.

In this context, consultants are currently able to analyze how and what employees print within a client corporation, to infer associated workflows and to suggest well adapted replacement solutions, reducing paper usage and increasing productivity. Therefore, consultants are currently collecting print volume information directly from the devices and the estimated time spent per employee on the different tasks or processes through a survey. They furthermore conduct individual interviews with selected particularly paper intensive employees to get a deeper understanding of their paper processes.

However, from a human point of view, it is difficult to motivate those employees to free time for talking about their print usage, in other words, about their ways of working. Indeed, this topic is often not motivating and fuzzy. Finally, the survey and interview approach also demands a lot of time from the consultant to identify and suggest processes to optimize. Furthermore, the consultant's proposals are often rather inspired by his prior experience with other companies than guided by the information collected in the target corporation. Thus, the consultant usually first concentrates on well-known ubiquitous standard processes and [semi] structured workflows, and often misses less frequent or less typical unstructured and hidden workflows that nevertheless exist in every work place.

There remains a need for a system and method of identifying unusual paper-intensive workflows in a more efficient, open, accurate and motivating fashion, with a need to gather employee knowledge and to combine it with machine learning techniques in a short term and collaborative workshop.

### INCORPORATION BY REFERENCE

The following references, the disclosures of which are incorporated herein by reference in their entireties, are mentioned:

U.S. patent application Ser. No. 14/607,739, filed Jan. 28, 2015, by Willamowski et al., and entitled “SYSTEM AND METHOD FOR THE CREATION AND MANAGEMENT OF USER-ANNOTATIONS ASSOCIATED WITH PAPER-BASED PROCESSES”

U.S. Publication No. 2011/0137898, Published Jun. 9, 2011, by Gordo et al., and entitled “UNSTRUCTURED DOCUMENT CLASSIFICATION”;

U.S. Pat. No. 7,366,705, Issued Apr. 29, 2008, by Zeng et al., and entitled “CLUSTERING BASED TEXT CLASSIFICATION”;

U.S. Pat. No. 8,165,410, Issued Apr. 24, 2012, by Perronnin and entitled “BAGS OF VISUAL CONTEXT-DEPENDENT WORDS FOR GENERIC VISUAL CATEGORIZATION”;

U.S. Pat. No. 8,280,828, issued Oct. 2, 2012, by Perronnin et al., and entitled “FAST AND EFFICIENT NONLINEAR CLASSIFIER GENERATED FROM A TRAINED LINEAR CLASSIFIER”;

U.S. Pat. No. 8,532,399, Issued Sep. 10, 2013, by Perronnin et al., and entitled “LARGE SCALE IMAGE CLASSIFICATION”;

U.S. Pat. No. 8,731,317, issued May 20, 2014, by Sanchez et al., and entitled “IMAGE CLASSIFICATION EMPLOYING IMAGE VECTORS COMPRESSED USING VECTOR QUANTIZATION”;

U.S. Pat. No. 8,879,103, by Willamowski et al., Issued Nov. 4, 2014 and entitled “SYSTEM AND METHOD FOR HIGHLIGHTING BARRIERS TO REDUCING PAPER USAGE”; and

CSURKA et al., “WHAT IS THE RIGHT WAY TO REPRESENT DOCUMENT IMAGES?”, Xerox Research Center Europe, Grenoble, France, Mar. 25, 2016, pages 1-35, are incorporated herein by reference in their entirety.

### BRIEF DESCRIPTION

In one embodiment of this disclosure, described is a computer-implemented method for gathering knowledge related to paper-intensive processes associated with one or more printing systems used in an organization to generate printed documents by a group of users. The method comprises generating a representative set of printed documents by tracking and storing all or a portion of the printed documents and associated metadata generated by the printing system over a predetermined duration of time and processing the representative set of printed documents to generate a plurality of clusters of printed documents, each cluster of printed documents including a subset of the representational set of printed documents which are associated with a predefined measurement of similarity. The method then assigns a set of users to label each cluster of printed documents, each set of users including a subset of users selected from the group of users and each subset of users associated with a relatively high degree of contribution to the cluster of printed documents, relative to other users, included in the group of users. After the users have labeled, the method is configured to receive the document labeling data from the subsets of users for one or more printed documents associated with each of the respective document clusters, the labeling data including one or more of a process type, a document type and a reason for printing the printed document. The document labeling information is used to train a classifier using all or part of the received document labeling data and associated printed documents and using the trained classifier, classifying one or more printed documents generated at the beginning of the process but not yet labeled. The method further compiles the label data for all or a portion of the representative set of printed documents, including label data directly provided by one or more users and label data provided by the method and generates one or more indicators representing the use of printed documents associated with one or more of the document type, the process, the user, a project and the reason for printing.

In another embodiment of this disclosure, described is a system for gathering knowledge related to paper-intensive processes associated with one or more printing systems used in an organization to generate printed documents by a group of users. The system comprises a print job tracking component configured to generate a representative set of printed documents by tracking and storing all or a portion of the printed documents and associated metadata generated by the printing system over a predetermined duration of time and a clustering component configured to process the representative set of printed documents to generate a plurality of clusters of printed documents, each cluster of printed documents including a subset of the representational set of printed documents which are associated with a predefined measurement of similarity. The system further includes an annotation component configured to assign a set of users to label each cluster of printed documents, each set of users including a subset of users selected from the group of users and each subset of users associated with a relatively high degree of contribution to the cluster of printed documents, relative to other users, included in the group of users, and receive document labeling data from the subsets of users for one or more printed documents associated with each of the respective document clusters, the labeling data including one or more of a process type, a document type and a reason for printing the printed document. A classifier component of the system is configured to be trained using all or part of the received document labeling data and associated printed documents and classify one or more of the printed documents generated by the print job tracking component which were not included in the plurality of clusters of printed documents generated by the clustering component and a compiler is configured to compile the label data for all or a portion of the representative set of printed documents, including label data directly provided by one or more users and label data provided by the classifier component. Lastly the system includes an indicator generation component configured to generate one or more indicators representing the use of printed documents associated with one or more of the document type, the process, the user, a project and the reason for printing.

In still another embodiment of this disclosure, described is a computer program product comprising a non-transitory recording medium storing instructions which, when executed by a computer processor, perform a method for gathering knowledge related to paper-intensive processes associated with one or more printing systems used in an organization to generate printed documents by a group of users. The method comprises generating a representative set of printed documents by tracking and storing all or a portion of the printed documents and associated metadata generated by the printing system over a predetermined duration of time. The representative set of printed documents is processed to generate a plurality of clusters of printed documents, each cluster of printed documents including a subset of the representational set of printed documents which are associated with a predefined measurement of similarity. A set of users is assigned label each cluster of printed documents where each set of users includes a subset of users selected from the group of users and each subset of users is associated with a relatively high degree of contribution to the cluster of printed documents, relative to other users, included in the group of users. The method receives document labeling data from the subsets of users for one or more printed documents associated with each of the respective document clusters, the labeling data including one or more of a process type, a document type and a reason for printing the printed document. The information is used to train a classifier using all or part of the received document labeling data and associated printed documents and using the trained classifier, classifying one or more representative set of printed documents which were not included in the plurality of clusters of printed documents previously clustered. The label data is compiled for all or a portion of the representative set of printed documents, including label data directly provided by one or more users and then generating one or more indicators representing the use of printed documents associated with one or more of the document type, the process, the user, a project and the reason for printing.

### BRIEF DESCRIPTION OF THE DRAWINGS

FIG. 1 is a graphical overview of a system and method for analyzing task-related printing;

FIG. 2 is functional block diagram of a system for analyzing task-related printing in accordance with one aspect of the exemplary embodiment;

FIG. 3 is flow chart of a system for analyzing task-related printing in accordance with another aspect of the exemplary embodiment;

FIG. 4 is a graphical overview of a hardware and spatial setup for individual work with a consultant;

FIG. 5 is a graphical overview of a hardware and spatial setup for collaborative work with a consultant in small groups;

FIG. 6 illustrates the phases of document selection and review;

FIG. 7 illustrates a representative consultant screen during document selection, review and labeling;

FIG. 8 illustrates a representative participant screen during document selection, review and labeling;

FIG. 9 illustrates a graphical overview of document labeling;

FIG. 10 illustrates a consultant/large screen document clusters and the participants working on them;

FIG. 11A illustrates a participant screen displaying an individual cluster document selection;

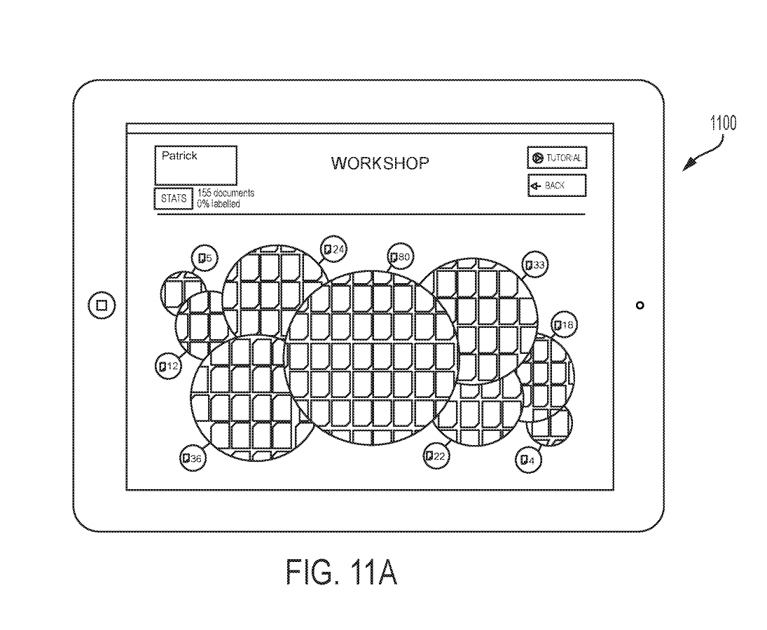

FIG. 11B illustrates a cluster document labeling screen;

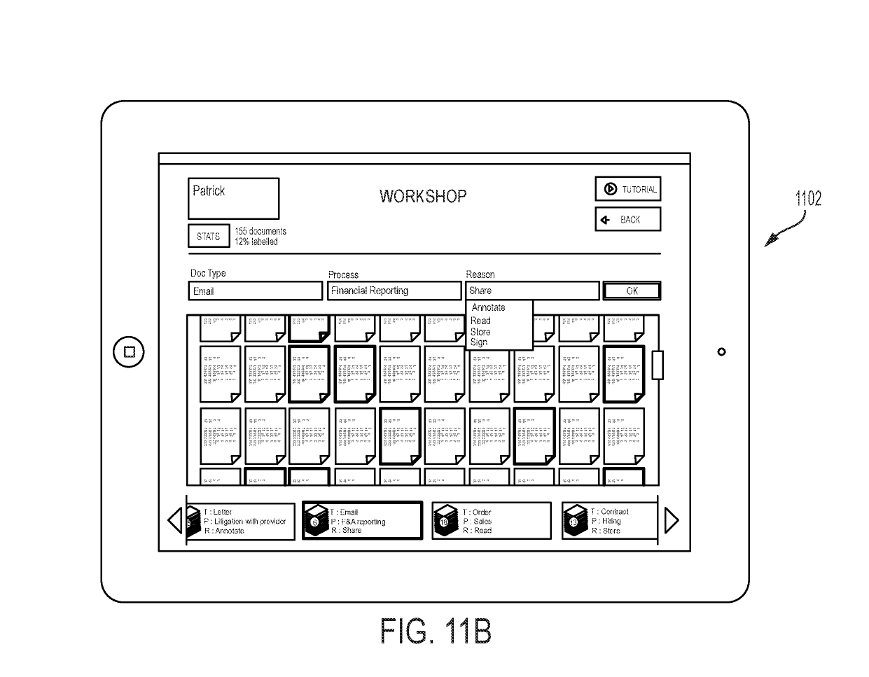

FIG. 12 illustrates a participant screen while in a free text labeling scenario;

FIG. 13 displays a consultant screen in a privacy mode showing individual participant performance and activities;

FIG. 14 illustrates a consultant screen in a privacy mode with invitations for participants to join collaborative groups;

FIG. 15A is a graphical view of a participant screen indicating document clusters and the participants working on the clusters;

FIG. 15B is a graphical view of a collaborative screen indicating document clusters and the labeling interface;

FIG. 16 is a graphical overview of the requalification phase;

FIG. 17 illustrates a consultant screen with a user experience of a requalification phase;

FIG. 18 is a graphical overview of the propagation phase;

FIG. 19 illustrates a consultant/large screen with a propagation effect visualization;

FIG. 20 is a graphical overview of the processes discussion phase;

FIG. 21 illustrates a consultant/large screen with a processes discussion animation.

### DETAILED DESCRIPTION

To more effectively gather knowledge about paper-intensive processes in an organization, a system and method for supporting the preparation, animation and execution of a collaborative workshop for high speed and efficient document labeling and workflow assessment is disclosed. The method is structured in several steps and phases, and the system provides different types of support and guidance throughout these various steps and phases. It enables on one hand a human facilitator to efficiently prepare and animate the workshop and to optimally engage the participants. This facilitator role can be fulfilled by an external consultant, specialized in the analysis and improvement of organizational paper-based work processes in general. The system enables on the other hand the individual workshop participants to collaboratively and efficiently label pre-selected documents. These participants can be a small number of selected employees working in the target organization, and the documents to label correspond to a selected set of paper documents produced by the participants in their work. The information provided as part of the workshop from users is then compiled and used to train a classifier to continue the task of labeling documents that remain unlabeled.

According to an exemplary embodiment the disclosed method and system structures the workshop organization by animating and executing in steps and phases. Below is described first the different steps and phases and then how the functionalities provided by the system support these individual steps and phases.

The method and system provided includes the following steps:

1. Workshop Preparation:
a. Document tracking: The system tracks and captures all paper-documents produced within a target organization over a significant period of time. The aim is to constitute a representative set of documents corresponding to all, or a specific portion, of the work processes taking place in the organization;
b. Defining the workshop scope: The system provides for the selection of an optimal subset of documents and participants for the proper workshop;
c. Document cleaning: The system provides for the participants selected in the previous phase in screening their documents to remove documents from the set not related to work;

2. Workshop Execution:
a. Labeling: The system provides for the participants to label documents, either individually or in participant groups, where documents are labeled either one-by-one or, preferably, in bulks, as document sets;
b. Requalification: The system provides for the consolidation of the document sets and labels produced in the previous phase to generate and validate a common vocabulary and understanding;
c. Propagation: The system propagates the labels agreed upon in the previous phase to all the remaining un-labeled documents, i.e., the documents captured in step 1.a;
d. Discussion: The system provides for the selection of paper intensive processes to envisage and elaborate possible paper-less improvements.

To provide for the different steps and phases the system includes the following processes/methods:

1. Document Clustering and Analysis:
a. During the workshop preparation phase, the system uses document clustering and analysis to support the facilitator in the definition of the workshop scope, i.e., the optimal selection of document clusters to consider, documents to label, and participants to include to sufficiently cover those clusters;
b. During the labeling phase, the system uses document clustering to periodically re-build new meaningful clusters from the remaining un-labeled documents, and to suggest groups of participants for collaborative labelling;

2. Document Categorization:
a. During the labeling phase, the system periodically evaluates the precision and recall of the previously labeled document sets through cross validation, thus providing the facilitator with indicators about the quality of the classifiers that can be trained based on the previously labeled document sets.
b. During the propagation phase, classifiers are trained from all the labeled document sets and applied to all the remaining un-labeled documents, including an evaluation of the confidence the system has in the resulting labels. This allows the system to evaluate and illustrate the contribution and value resulting from the workshop for the overall identification of paper processes.

3. Monitoring Workshop Progression Indicators:
a. During the labeling phase, the system continuously evaluates
   i. the document cluster coverage, i.e. how many documents have been labeled and how many remain to be labeled in each cluster, and
   ii. the participants' actual labeling velocity.

Based on these indicators the system may generate suggestions—either directly or indirectly through the mediation of the facilitator—that one or more participants switch clusters and/or leave/join groups for more efficient labeling and/or that the workshop transitions to the next phase, the requalification phase.

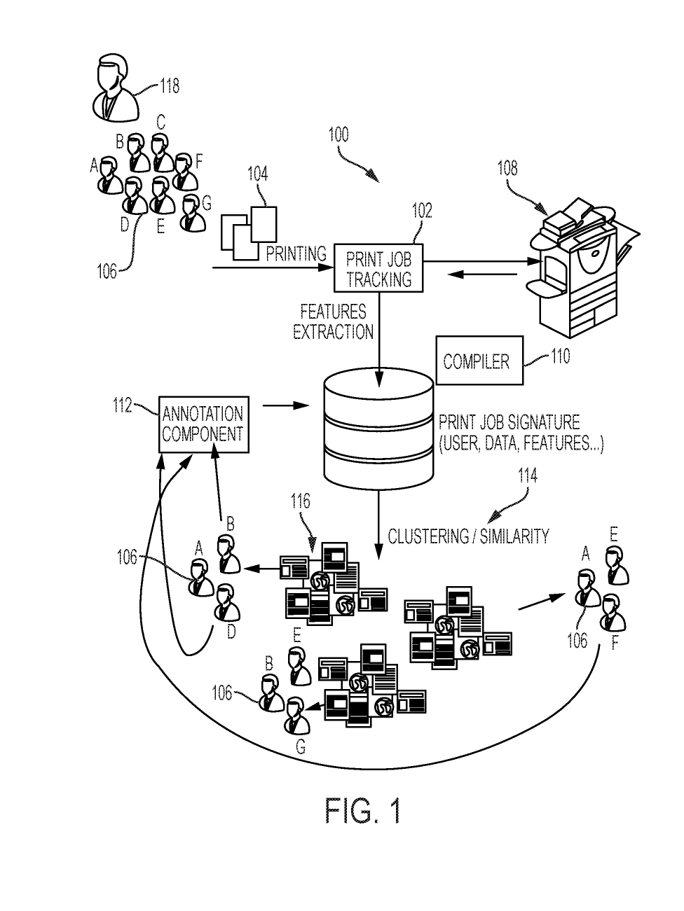

With reference to FIG. 1, an overview of an exemplary system 100 and method to collaboratively identify paper intensive processes is shown. An exemplary workflow identification system 100 aims at providing an environment in which multiple participants, hardware, and software interact at the same time and optimally guide participants to share their individual knowledge and experiences around processes and printing to enhance the experience that is usually considered time consuming and de-motivating.

A consultant 118 is the facilitator of the experience. The consultant 118 knows how to progress towards the ultimate goal of paper workflow identification and optimization and with the knowledge of previous experiences in other companies, knows how to guide and motivate the participants through a smooth experience. The consultant 118 is assisted by the system which introduces a clear progression metrics and on the fly indicators and guidelines, and is the human representative mediating between the system and the workshop participants.

Users 106 are employees of the target organization who print documents in the context of their work and who have the knowledge about the purpose of their printing. They contribute their individual view of the work processes from their different angles, with respect to their department or role in the company. They are able to grasp and recognize a document they have printed and to explain why they had to print it. They are able, as well, to discuss these points all together to reach a common understanding.

The system 100 includes a print job tracking component 102 that intercepts print jobs 104 that are sent by different users 106 within the organization to a printing infrastructure 108 (and/or which receives information on the print jobs from the printing infrastructure, such as print logs). The print job tracking component is configured to track and store all or a portion of the printed documents and their metadata that is generated by the printing system over a specified period of time. The number of users and print jobs is not limited and each user may generate one or more print jobs for printing on the printing infrastructure 108.

The clustering component 114 identifies clusters 116 of similar print jobs 104. The clustering is based on the assumption that similar print jobs will belong to similar tasks and that users have work roles corresponding to a specific subset of tasks and thus print essentially the corresponding types of print jobs. Thus, print jobs which have no annotations can be clustered based on the similarity of their print job signatures to those of annotated jobs. Each cluster of printed documents includes a subset of the representative set of printed documents generated by the job tracking component.

An annotation component 112 is configured to assign a subset of users to review and label each cluster of printed documents generated by the clustering component. The set of users 106 includes users who have a relatively high degree of contribution to the representative set of printed documents. The annotation component 112 assigns a subset of these users to each cluster based upon the users' 106 relatively high degree of printing of the documents in the given cluster. The annotation component 112 then receives document labeling data from the subsets of users 106 for each cluster for one or more of the printed documents 104. The labeling data received by the annotation component includes one or more of a process type, a document type, and a reason for printing the printed document. A compiler 110 is configured to compile all the received label data for all or a portion of the representative set of printed documents generated by the job tracking component. The label data used by the compiler can be label data provided directly by one or more of the users and label data provided by the classifier component.

A classifier component 242 is configured to be trained using all or portions of the document labeling data as well as using associated printed documents. The classifier component 242 then classifies one or more of the printed documents generated by the print job tracking component 102 which were not included in the plurality of clusters of printed documents 104 generated by the clustering component 114.

A compiler component 110 is configured to compile the label data for all or a portion of the representative set of printed documents 104. The compiler compiles label data that has been directly provided by one or more users 106 as well as label data provided by the classifier component 242.

The system further includes an indicator generation component 244 that is configured to generate one or more indicators representing the use of printed documents associated with the one or more document type, the process, the user, a project, and the reason for printing.

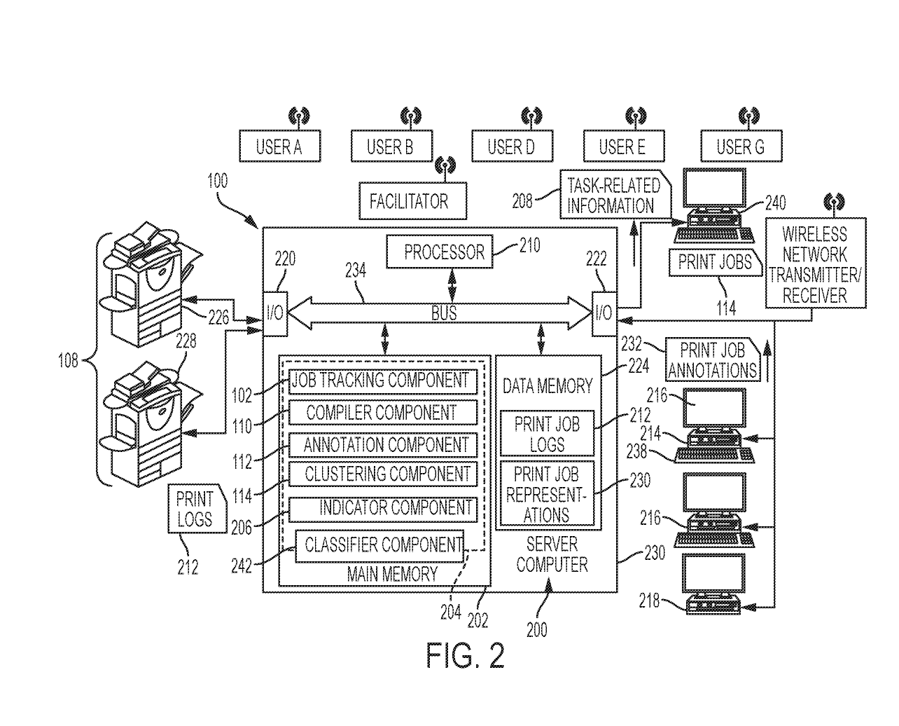

As illustrated in FIG. 2, the system 100 may suitably be hosted by one or more computing devices 200. For example, the system 100 includes main memory 202 which stores instructions 204 for performing the exemplary method, including the print job tracking component 102, features extractor 110, annotation component 112, and clustering component 114, described above with reference to FIG. 1.

An analysis component 206 generates task-related information 208, based on the clustering and annotations, which is output from the system 100. In the exemplary embodiment, the components 102, 110, 112, 116, 206 are in the form of software which is implemented by a computer processor 201 in communication with memory 202.

In the illustrated embodiment, the computing device 200 receives print job information comprising print jobs 104, and/or information extracted therefrom, such as print logs 212, via a network. In one embodiment the print jobs 104 are received by the job tracking component 102 from a plurality of client computing devices 214, 216, 218 linked to the network, that are used by the respective users 106 to generate print jobs. However, it is to be appreciated that print job information for the submitted print jobs 104 may alternatively or additionally be received from the printing infrastructure 108 or from a print job server (not shown), which distributes the print jobs 104 to the various printers in printing infrastructure 108. The print job information 104, 212 is received by the system 100 via one or more input/output (I/O) interfaces 220, 222 and stored in data memory 224 of the system 100 during processing. The computing device 200 also may control the distribution of the received print jobs 104 to respective printers 226, 228 of the printing infrastructure 108, or this function may be performed by another computer on the network.

The feature extractor 110 extracts features from the print job information. The extracted features are used to generate a representation 230 of each print job, which may be stored in memory 224.

The annotation component 112 receives, as input, print job annotations 232 for at least some of the print jobs 104, via the network, e.g., from the client computing devices 214, 216, 218 and stores the annotations, or information extracted from them, in memory 112. The annotations may include task-related information and/or information on constraints provided in the form of a note which limit or prevent the user's ability to use a digital version of the printed document rather than printing a paper copy. Alternatively, the task-related information may include a task category selected from a plurality of task categories, or information from which the task category may be inferred. The constraint-related information may include a constraint category selected from a plurality of constraint categories, or information from which the constraint category may be inferred.

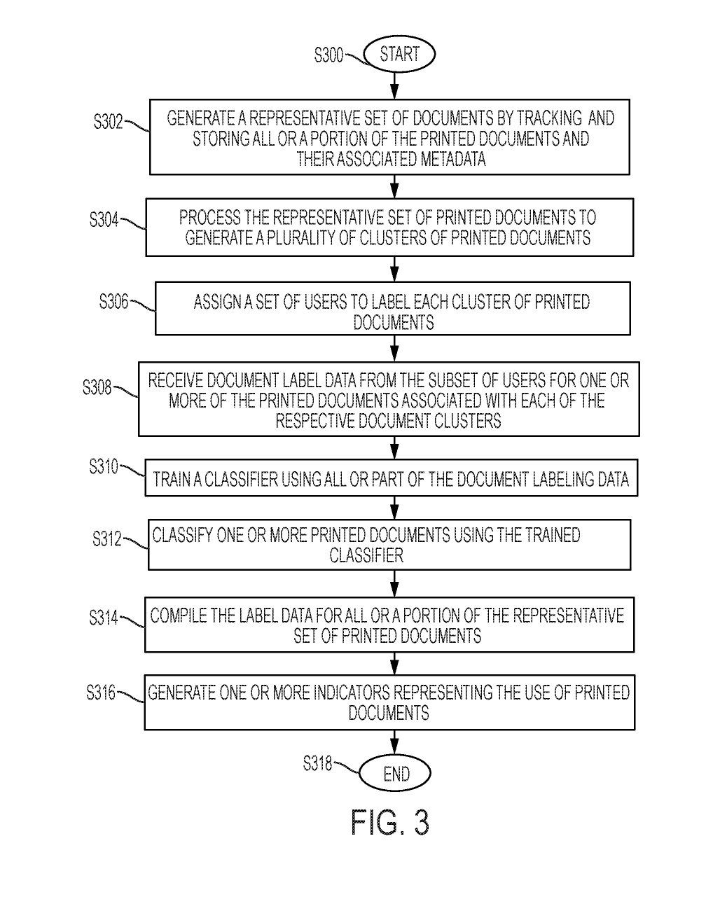

The clustering component 114 may be trained, on the annotated (labeled) print jobs and is then able to cluster a set of labeled and unlabeled print jobs into a plurality of clusters 116. Hardware components 202, 210, 220, 222, 224 may communicate via a data/control bus 234. The processor 210 executes the instructions for performing the method outlined in FIG. 3.

The client devices 214, 216, 218 may each communicate with one or more of a display 236, for displaying information to users, and a user input device 238, such as a keyboard or touch or writable screen, a cursor control device, such as mouse or trackball, a speech to text converter, or the like, for inputting text and for communicating user input information and command selections to the respective computer processor and to processor 210 via network.

The computer device 200 may be a PC, such as a server computer, a desktop, laptop, tablet, or palmtop computer, a portable digital assistant (PDA), a cellular telephone, a pager, combination thereof, or other computing device capable of executing instructions for performing the exemplary method.

The memory 202, 224 may represent any type of non-transitory computer readable medium such as random access memory (RAM), read only memory (ROM), magnetic disk or tape, optical disk, flash memory, or holographic memory. In one embodiment, the memory 202, 224 comprises a combination of random access memory and read only memory. In some embodiments, the processor 210 and memory 202 may be combined in a single chip. The network interface 220, 222 allows the computer 200 to communicate with other devices via a computer network, such as a local area network (LAN) or wide area network (WAN), or the internet, and may comprise a modulator/demodulator (MODEM) a router, a cable, and/or Ethernet port. Memory 202, 224 stores instructions for performing the exemplary method as well as the processed data 208.

The digital processor 210 can be variously embodied, such as by a single-core processor, a dual-core processor (or more generally by a multiple-core processor), a digital processor and cooperating math coprocessor, a digital controller, or the like. The exemplary digital processor 210, in addition to controlling the operation of the computer 200, executes instructions stored in memory 204 for performing the method outlined in FIG. 3.

The client devices 214, 216, 218 may be configured as for computing device 200, except as noted.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 2 is a high level functional block diagram of only a portion of the components which are incorporated into a computer system 100. Since the configuration and operation of programmable computers are well known, they will not be described further.

With reference to FIG. 3, a method for analysis of the reasons for printing print jobs is shown, which can be performed with the system of FIG. 2. The method begins at S300.

At S302, print job information 104, 212 is acquired for a collection of print jobs generated by a set of users 106, such as company employees, and stored in computer memory 224. The method generates a set of representative printed documents by tracking and storing all or a portion of the printed documents and their associated metadata generated by the printing system over a predetermined duration of time.

At S304 the representative set of printed documents is processed to generate a plurality of clusters. The clusters contain a subset of printed documents which are associated with a predefined measurement of similarity.

At S306, users of the system are assigned to label the subset of documents included in various clusters. The set of users are selected from a group of users where each user in a group has shown a relatively high contribution to the cluster of printed documents i.e. the user has created or printed a large portion of the documents contained in the cluster.

At S308, user annotations 230 are received by the system 100 and stored in memory.

At S310, using all or a part of the document labeling information received from the users is used to train a classifier.

At S312, using the trained classifier, the set of representative documents that have not yet been classified by the users is classified by the system.

At S314, the label data generated by the users or by the compiler is compiled including the label data directly provided by the one or more users and the label data provided by the compiler.

At S316, the method generates one or more indicators representing the use of the printed documents associated with one or more document type, the process, the user, a project, and the reason for printing. The method ends at S318.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively or additionally, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method. As will be appreciated, while the steps of the method may all be computer implemented, in some embodiments one or more of the steps may be at least partially performed manually.

Further details of the system and method will now be described.

Print job tracking systems that provide the basic functionality of the exemplary print job tracking component 102, such as intercepting print jobs issued through a print infrastructure and extracting the corresponding user name, document title, document length, and similar information are readily available.

Various procedures for annotation are contemplated which can be used individually or in combination. For example, the annotation process can be initiated spontaneously by the users or when requested by the system, for example, to use active learning in order to validate or refine the actual clustering. Users may annotate one (or a set of) selected print job(s), thereby associating it to a corresponding one of a set of tasks and identifying constraints on printing. In another embodiment, the user may annotate a point in time or time frame with the task they were mainly performing at that time (e.g., reviewing papers for a conference, preparing for a customer visit, etc.) and the system identifies print jobs submitted during that time frame and associates them with that task.

In one embodiment, users can provide annotations when submitting print jobs. In this case, the annotations may be integrated into the existing printing selection process, e.g., within one of the already existing notification pop-up windows informing the user that his print job has been sent to or processed by the printer. In one study, it was shown that at least a significant portion of users would have been motivated to do so to pinpoint paper-based processes that should evolve to digital form (e.g., legal documents or forms requiring a signature).

Users can also provide annotations of print jobs or time frames at a later time from a print history view. In one embodiment, a graphical user interface which provides a Personal Assessment Tool (PAT), as described above, provides a print history view visualizing the user's print jobs over time. For example, the print history provides the document title and length. In addition, users may be provided with access to the visual document content, i.e. the document page images. From this information, users can associate a set of print jobs to the task to which they belong. Alternatively, users can specify a time frame and associate it to one or a set of tasks or to a particular event generating associated tasks. This indicates that the print jobs they initiated in this time frame correspond to the tasks they were primarily executing in that time frame.

According to an exemplary embodiment, the features extracted from the print jobs, such as the visual features associated to each print job, enable them to be automatically grouped into clusters. Each cluster can be considered as corresponding to a different task or note category. This helps to detect documents involved in the same process or task, since they are often associated with documents of similar structure. For example, it may be expected that documents associated with organizing travel (plane e-tickets, hotel reservations, travel map, etc.) or with the filing of intellectual property documents (invention disclosure, patent applications, copyright forms, publications) may occur more frequently in some groups than others.

Based on features that are extracted for each document and the subset of annotated documents, the annotation component of the system learns clustering parameters for a set of clusters and propagates the labels to all the documents which have not yet been labeled. This may be performed using a supervised learning technique based on existing labels or a semi-supervised learning method.

In one exemplary embodiment, the labeled print job data can be used to identify parameters of clusters for the clustering model, which is then used to assign unlabeled print jobs to clusters based on their extracted features.

In another embodiment, the print job clustering system produces clusters of similar print jobs, initially roughly grouping, for example, print jobs related to similar basic types of documents, e.g. forms, letters, emails, presentations, etc. These initial clusters can then be refined, validated and associated to the corresponding tasks using the labels or other information input from the users who issued the jobs. Crowd sourcing information from the users, lets them annotate a small portion of their print jobs indicating to which task they correspond and also why the document was required to be in paper form. The system then uses the collected information to improve the clustering and this process can iterate until the results obtained are consistent. This approach has the advantage of requiring only a limited number of annotations and thus only a limited number of users annotating their jobs. The number of annotations needed may depend on the number of different tasks within the organization, the variability of corresponding documents involved, and on the quality of the clustering mechanism.

Once the clustering parameters are learned, unlabeled print jobs can be automatically assigned to clusters based on their print job representations alone.

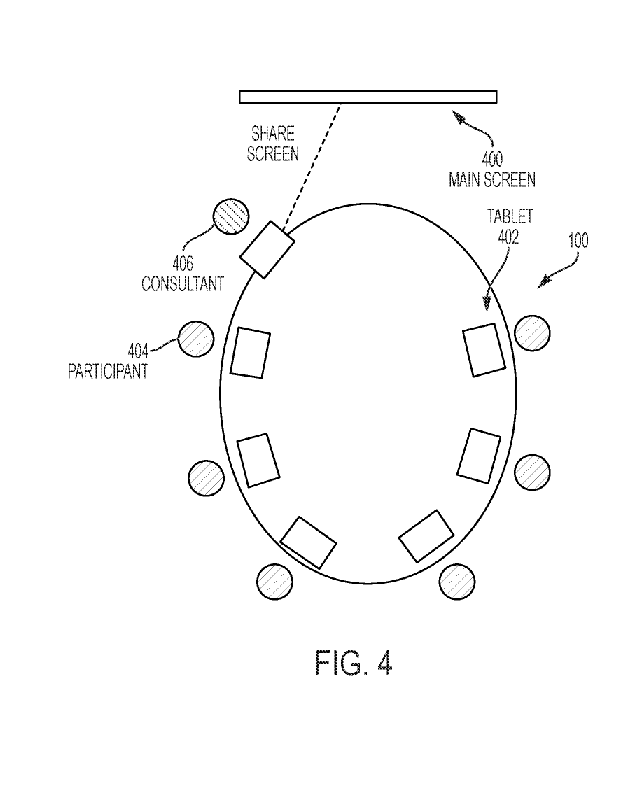

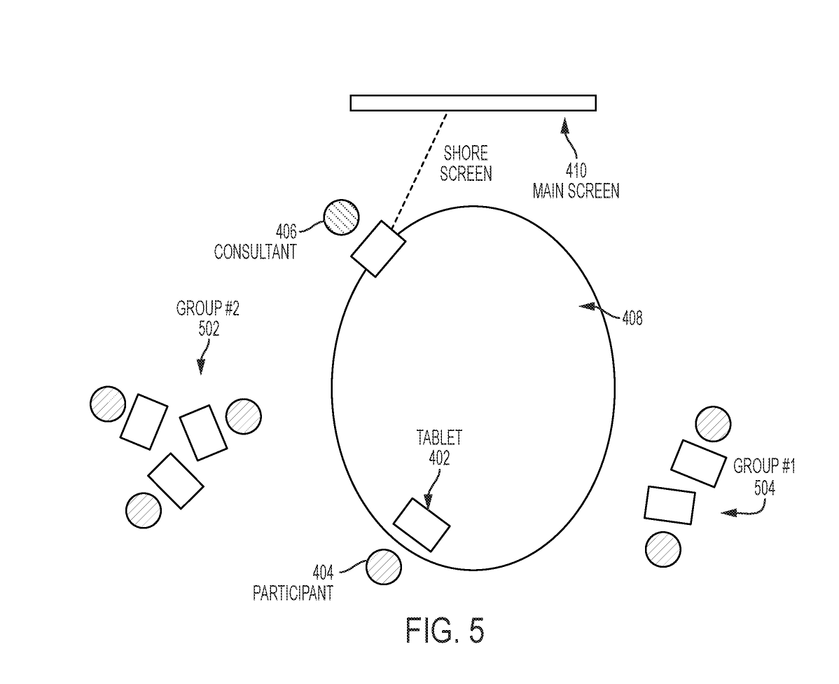

In FIGS. 4 and 5, the system 100 incorporates hardware and software to support the collaborative aspect of the data collection. Knowledge sharing through connected individual tablets 402 distributed to all participants 404 and the consultant 406. While the participant's tablet 402 shows his individual printed documents and provides tools to identify and label them, the consultant's tablet 408 provides him with advanced information about the workshop progression. A large screen display 410 allows to share information about the global workshop progression and the participants' 404 actual activity with all the workshop participants.

These tablets 402, 408 are equipped with proximity sensors, such as a Bluetooth® or eBeacon® (when linked to a specific place in the room), to detect the proximity with other tablets and enable a collaborative labelling mode. With this capability, participants can move across space, and work in collaborative groups 502, 504 and share the screen to support group work and discussion.

The exemplary method employed with the hardware system performs multiple tasks. The method collects and analyses a set of printed documents to cluster them by similarity and proposes an optimal list of participants to cover the resulting clusters. It displays documents on the participants' tablets 402 by similarity to simplify their labeling suggesting labels when possible. Documents are fully readable for the owner and obfuscated for others during the collaborative labelling mode. It monitors the individual participant's 404 progression and speed to alert the consultant when a participant is blocked and suggests groups of participants that may work together when they have printed similar documents in a cluster. The method identifies possibly problematic labels given by the participants to ask for clarification and propagates knowledge captured during the labelling experience to un-labelled documents to illustrate the impact of the workshop effort on the overall set of printed documents. Lastly, it synthetizes the intermediate status and final results of the workshop at its various stages and supports live discussion between the consultant and the participants.

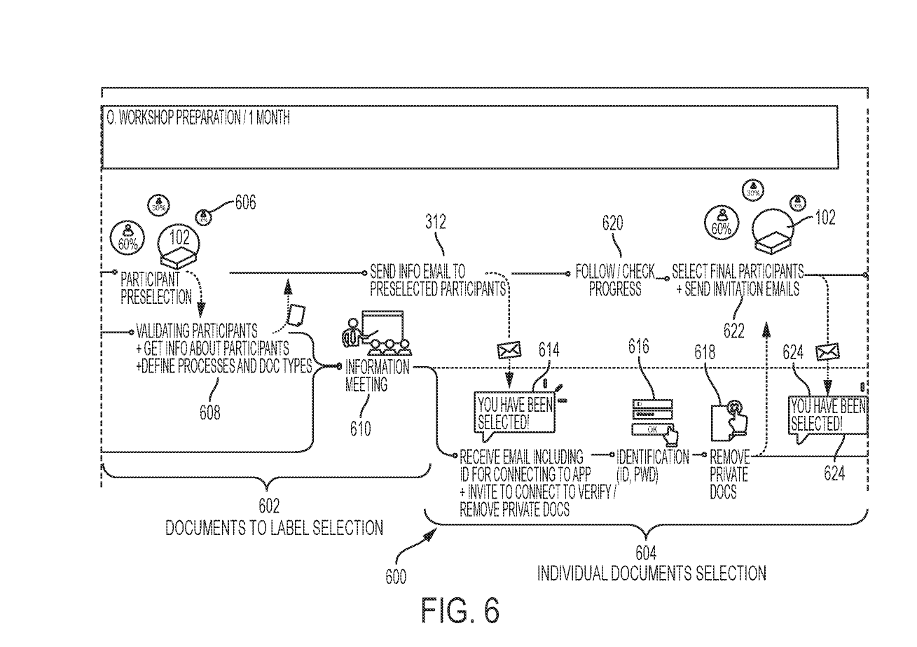

Before data collection begins, the system tracks and captures all the documents printed within the target organization and stores this information along with page images and meta-data (document owner) for further processing during the workshop or during its preparation. With respect to FIG. 6, the data collection preparation 600 is completed in two phases. In the first phase the system supports the selection of the participants 606 of the workshop and the documents to label during the workshop based on an analysis of the whole set of documents printed during the prior tracking period. In this first phase, the system interacts with the workshop facilitator to elaborate and validate this selection 608, 610, 612. In the second phase, the participants are individually asked to confirm their participation in the workshop and do a quick pre-screening of the documents that they will be asked to label 612, 614, 616, 618, 620, 622.

The idea of the workshop is to collaboratively identify paper-intensive processes within a short time frame. To be able to realistically and effectively achieve this objective, the number of workshop participants 606 on one hand and the number of documents 624 the participants may be asked to label on the other hand must first be limited to realistic and reasonable values. To effectively select the workshop participants and respective documents to label, the system provides support for document clustering, identifying user contribution, and selecting clusters and participants.

In selecting the appropriate list of documents to be used, the system provides support for document clustering. During document clustering, the system clusters the whole set of documents into N clusters, identifying at the same time for each cluster a set of representative documents whose labeling allows to cover the major part of the cluster. Based on the owners of the selected documents, the system identifies for each cluster the set of contributing users with their amount of contribution (in % of documents/pages) and proposes for each cluster a selection of participants required to cover the cluster (entirely or at least a significant portion). Lastly, given the maximum number of participants for the workshop and the maximum number of documents each participant may be asked to label, the system then proposes the clusters to consider and the participants to include in the workshop. Indeed it may be impossible to aim for total coverage, and preferable instead to consider and focus only on some key clusters in a (first) workshop.

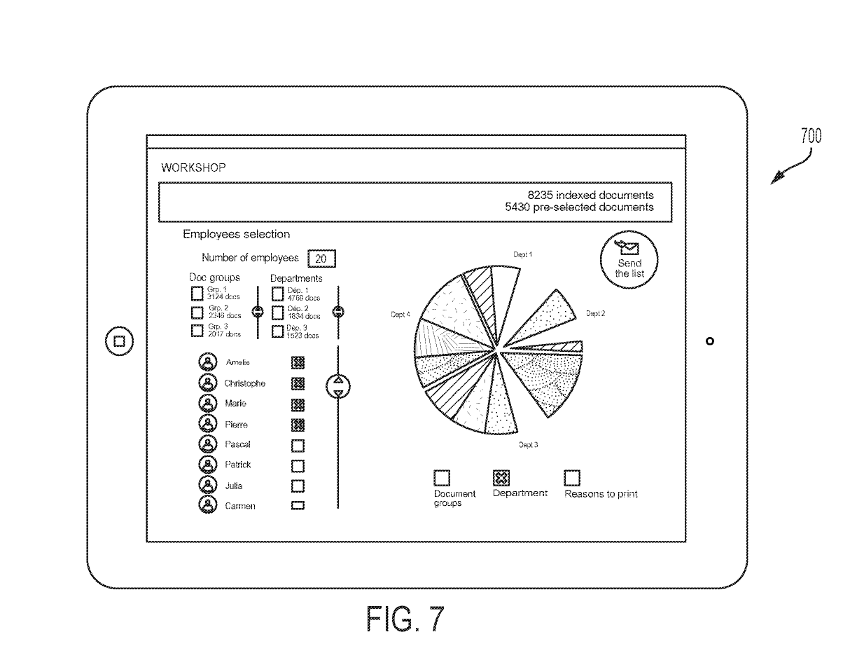

With respect to FIG. 7, the selected documents and proposed participants are shown to the consultant 700. The consultant can then either accept or modify the selection proposed by the system and rerun the process until an acceptable proposal is reached 710, 712. Various reasons for such iterations may exist, e.g., proposed participants may not be available at the target date, and have to be excluded; or a particular cluster may be particularly interesting to label and is preselected manually. Once the clusters and participants are selected, the system automatically identifies for each participant the set of documents they will be asked to label during the workshop such that the selected clusters are covered as much as possible.

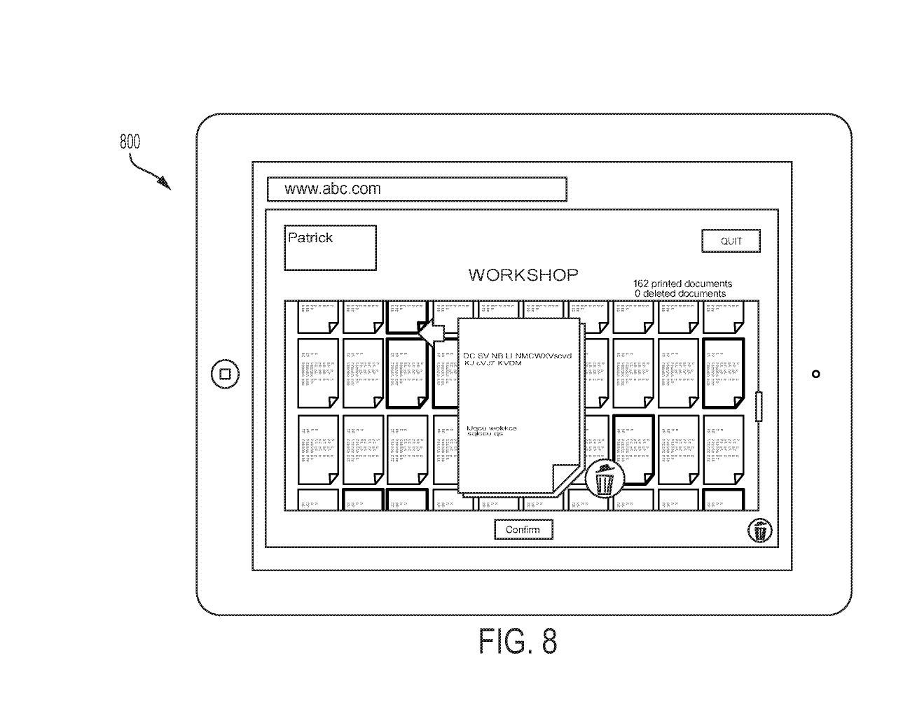

With respect to FIG. 8, after the set of proposed documents and participants is made and approved by the consultant, the participants are individually invited to confirm their participation 814 in the workshop and go through a preliminary document cleaning phase 816, 818. Indeed, in the previous phase the system has pre-selected, for each participant, a set of documents that he or she will be asked to label during the workshop. However, some of those documents may be personal, not work-related and thus irrelevant for the workshop. To address this issue, and also to preserve the participant's privacy, the system allows each participant to log into the system, on his or her personal computer, and go through those documents 800. The participants can remove irrelevant documents, and finally validate the remaining document set as suitable for labeling in the workshop. To further ensure confidentiality, also during the workshop, all these documents will only be displayed to the owner himself in their clear form and displayed in an anonymized version when shown to the other workshop participants.

The system keeps track of the overall number of documents/pages removed by all the participants in this phase: they are summed up and mentioned in the final report, as X% of documents/pages printed in a non-work related context.

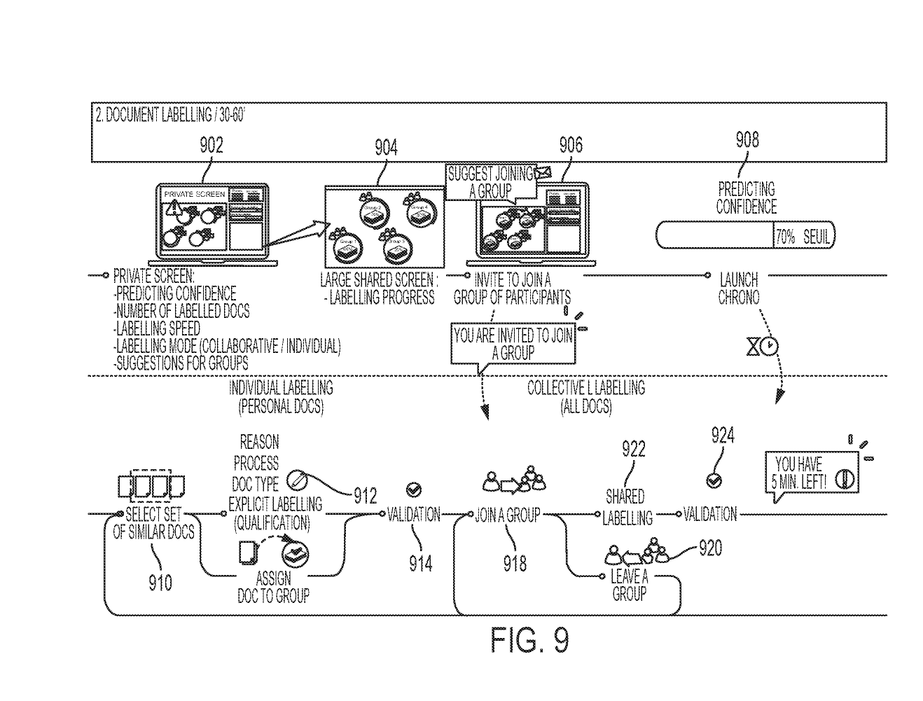

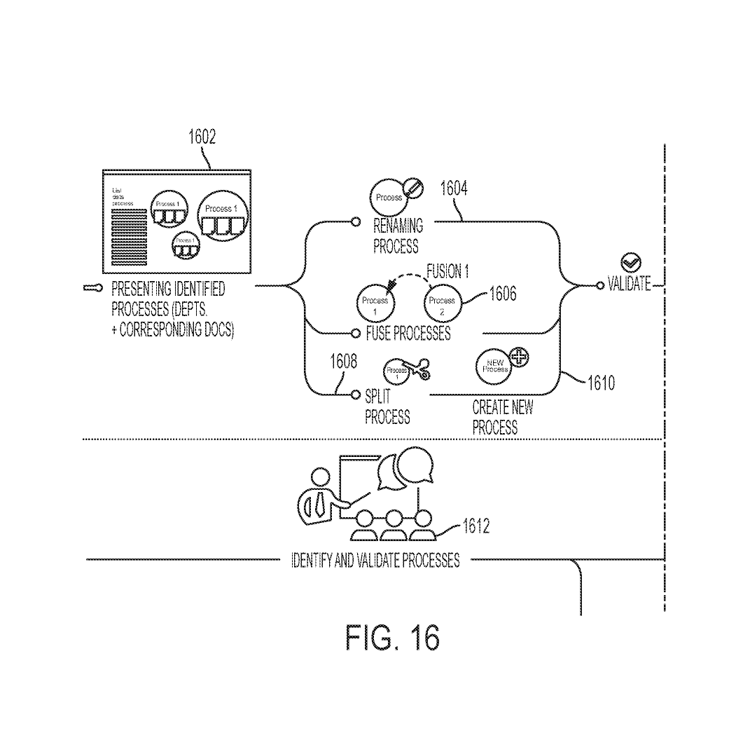

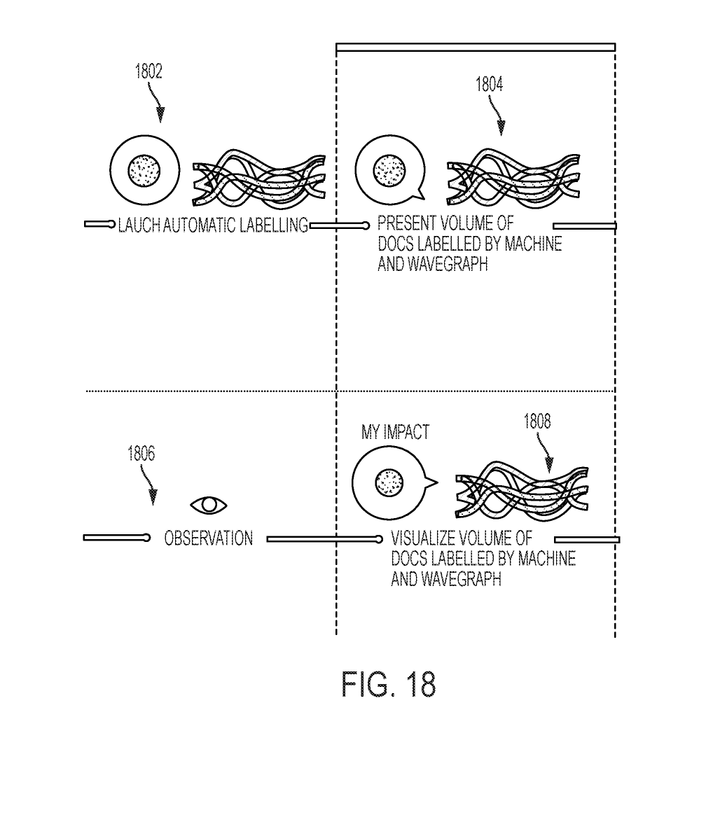

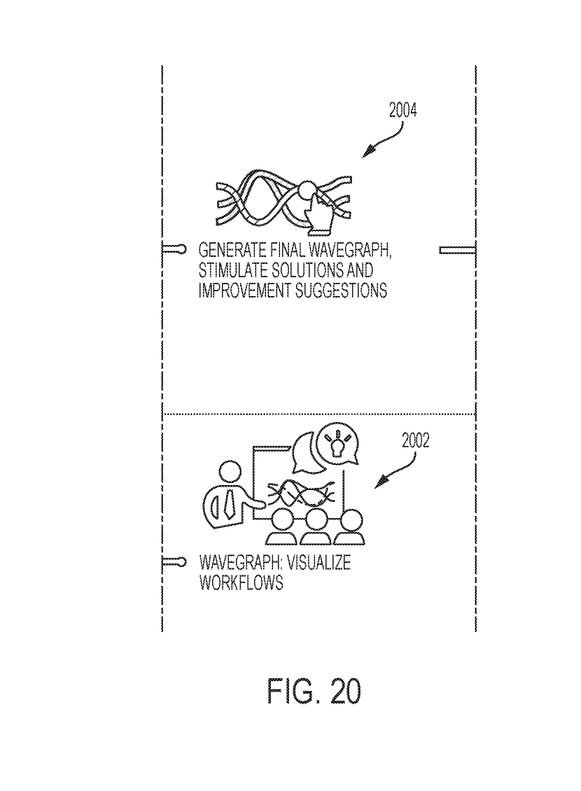

After the participants have agreed to participant and the proposed documents have been reviewed and determined relevant for the workshop, the document classification workshop can begin. The workshop itself consists again of several phases, the document labeling phase, see FIG. 9, the requalification phase, see FIG. 16, the propagation phase, see FIG. 18, and the final discussion phase, see FIG. 20, described in more detail below. The system supports the workshop facilitator in animating the workshop, and in managing the duration of and the transition between the different phases.

During the workshop, and fed by the system, a large screen display permanently shows information about the workshop's actual progression and status. This display also allows the workshop facilitator to gather all the participants around it at the key moments of the workshop, and to animate the discussions that involve the whole group.

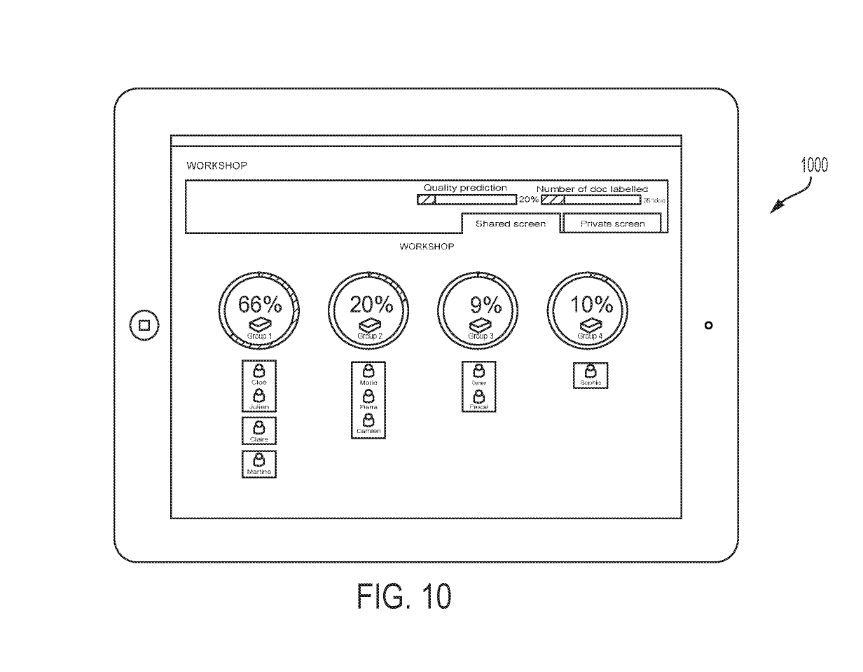

Besides this large display the facilitator also has a private display FIG. 10, through which the system provides him with a more detailed analysis of the actual workshop progression and activities of the participants 1002, 1004, 1006, 1008, and suggestions on how to influence its course of progression, for instance by re-directing the attention of the participants on particular tasks.

Concerning the participants, for the duration of the workshop each of them receives a tablet, allowing him/her to interact with the system and the other participants. This tablet gives each participant access to his/her personal documents that he/she is supposed to label, i.e., to the documents he/she printed during the observation period and has pre-screened before the workshop.

Labeling phase.

The objective of the labeling phase is to label all the documents selected for the workshop with (1) the process to which they belong, e.g., billing, (2) their document type, e.g. letter, and (3) their print reason, i.e. archive, annotate, distribute, read, or sign.

With respect to FIG. 9, the labeling phase starts with a visualization of the actual document clusters that require labeling. The consultants have a private screen 902 which allows them to view the documents to be labeled and classified. This visualization furthermore shows for each cluster 904 its size in terms of number of documents, and the name of the participants actually working on labeling documents in that cluster (if any). During the labeling phase this visualization is continually shown and updated on the large screen display 900. The large screen display 900 contains furthermore information about the workshop progression in terms of documents labelled and the expected propagation effect by applying machine learning and classification to the remaining documents 902, 904, 906, 908. During the labeling phase, the participants begin labeling and classifying documents individually based upon similarities 910. The documents are labeled 912, 914 and then associated into groups for validation 916.

Each participant has a corresponding view of the clusters displayed on his personal tablet, augmented furthermore with a suggestion provided by the system on a cluster to start 1100, see FIG. 8. The suggestion typically indicates the cluster where the expected value of the participant's contribution is the highest. From this initial screen each participant selects the cluster to work on. This opens the proper labeling screen on the tablet visualizing, see FIG. 8, the participant's documents belonging to that cluster and enabling him or her to label the document 1102.

On this labeling screen the participant's documents are ordered by similarity, i.e., visually similar documents appear side-by-side. At the same time the biggest sets of similar documents appear grouped at the top. This facilitates the selection of large sets of documents at a time for labeling them together, all-in-one. This allows to progress significantly faster than by labeling documents in a one-by-one fashion.

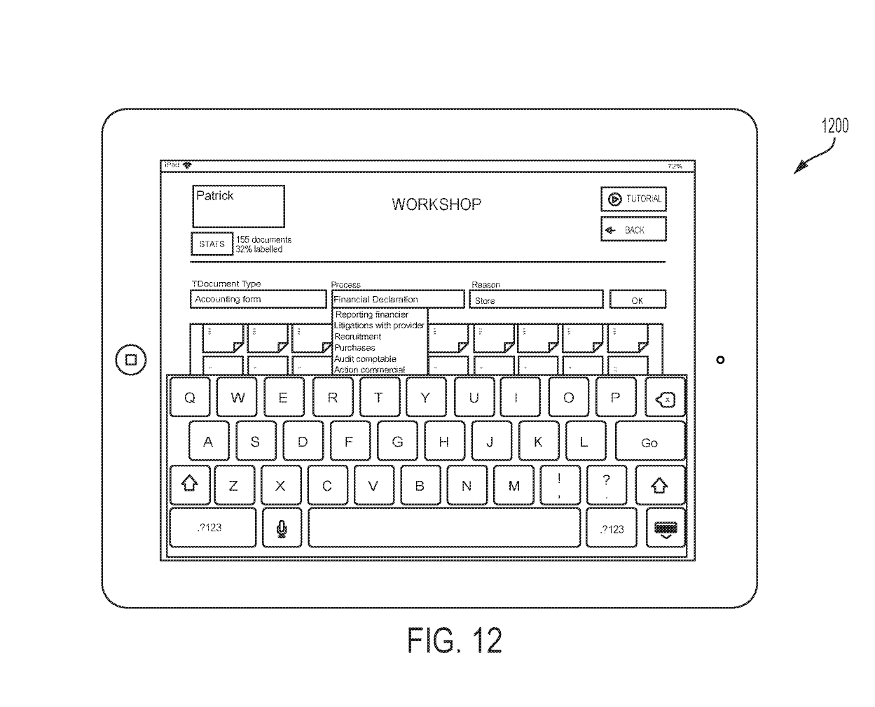

Whenever the users selects one or more documents on this labeling screen, the system automatically suggests labels for those documents, in particular for the document type, an attribute that is indeed in general very much determined by and correlated with the visual appearance and similarity of documents one with the other. If similar documents have already been associated with a given document type also the corresponding process and print reason can be proposed to the participant to facilitate labeling. However, the participant can always accept or change these suggested values and enter different values as free text 1200 as shown in FIG. 12.

Whenever this labeling process becomes tedious or cumbersome for the participant he or she can decide to stop working on the current cluster and return to the cluster visualization to select another one. At that point of time, i.e. whenever a participant leaves a cluster, the system restarts a new clustering process only with the remaining un-labeled documents, i.e., removing all documents that have in the meanwhile been labeled by all the participants. Thus, the partition in clusters evolves each time a participant leaves a cluster, and the participant will return to a new clustering view, different from the one accessed in the previous round and re-organizing the remaining documents according to their visual similarity.

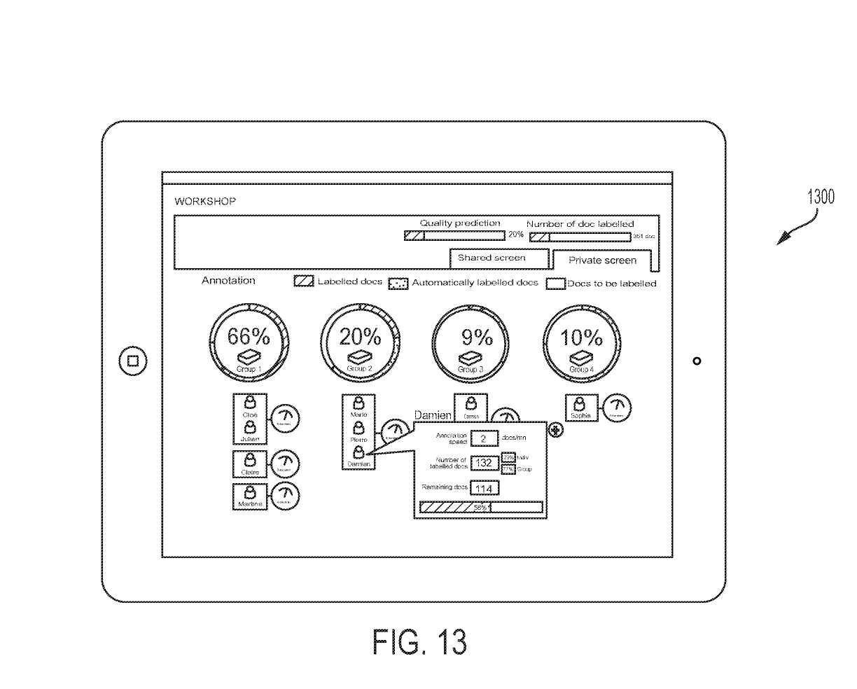

With respect to FIG. 13, each re-clustering step, the system also updates the document clusters displayed on the main screen as well as the related participants' activities and the current overall progression of the labelling effort, thus keeping the shared overview of what is going on up to date for everyone. At the same time the system updates also the facilitator's private display, indicating furthermore new participant-cluster combinations and opportunities, helping the facilitator to animate the workshop. The system provides thus the participants on one hand with guidance, even if participants always have the opportunity to deviate and follow their own path. The system provides on the other hand the facilitator with hints on possible improvements (see below) and information to animate the discussion if it the process is slowing down 1300.

Participants can work individually as described above. However this may become tedious, especially when the size of the sets of similar documents that can be labeled together in one shot becomes too small. In that case, participants can also work together as a group, i.e., visualize and label all their documents in a common view, shared across their personal tablets. Participants may create or join an already existing group of participants at any time if they have documents that belong to a common cluster.

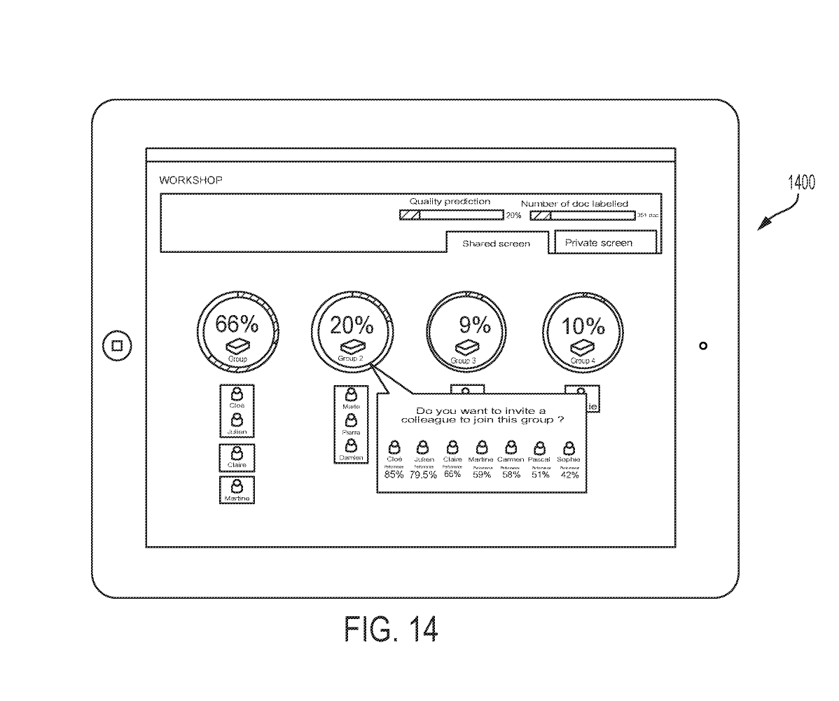

With further reference to FIG. 14, the system can also detect when collaborative labeling is the better option and encourage it by proposing to the participants (either directly or mediated by the facilitator) to join others in their labeling effort 1400. Therefore, the system monitors the progression and labeling speed of each individual participant in the background; whenever it detects a significant drop in speed, it may suggest to the participant to join/build groups. Another reason to suggest that participants join/build a group for collaborative labeling is that this is particularly efficient whenever the participants share many similar documents within a cluster. This is again a feature the system can monitor to initiate corresponding grouping actions.

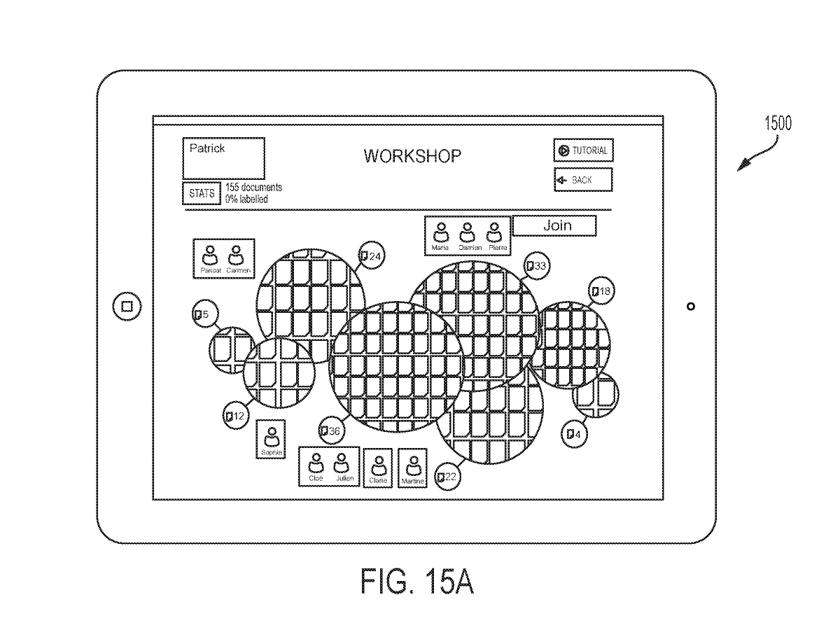

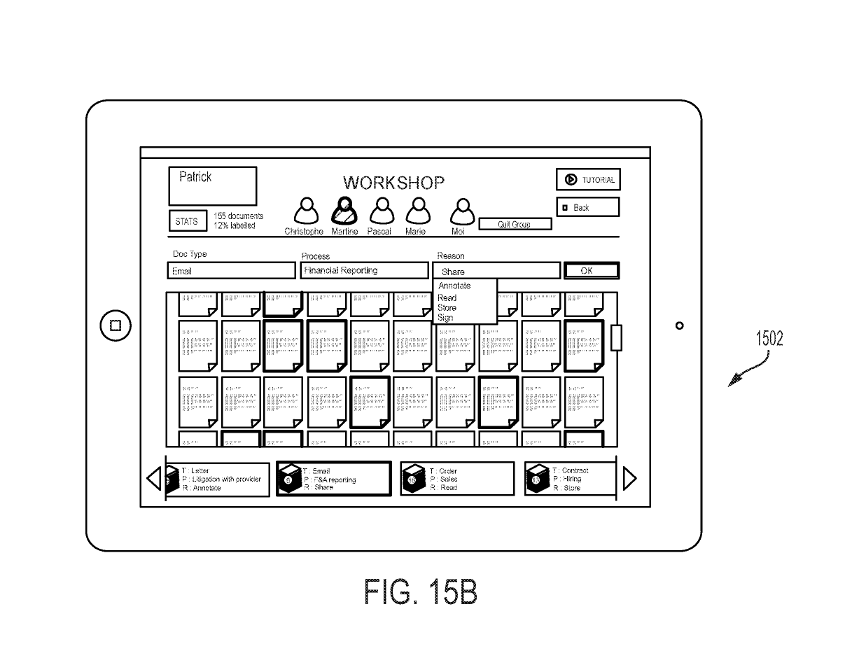

With reference to FIGS. 15A and 15B, to support collaborative labeling as a group, the tablets belonging to the different participants constituting the group are connected in a master-slave mode: one tablet becomes the master managing the display and interaction, while the others follow and display the same view and interaction 1500. In this shared view, each participant's tablet only visualizes his or her personal documents in their clear and plain version while visualizing those belonging to the other participants in their anonymized version 1502.

In order to recognize a group and simplify the communication between participants to qualify documents, people need to be physically close. Several well-known technical solutions, such as eBeacon®, or direct Bluetooth®, can be used to detect tablet proximity and automatically share screens of participants close to one another. This required proximity facilitates also the oral discussion during the labeling process.

Requalification phase.

With reference to FIG. 16, when all documents in the clusters are labeled and covered or when progression and labeling speed remain continuously low 1602, the system, with the mediation of the facilitator, moves to the next phase of the workshop, the requalification phase 1612. The motivation for this phase is to correct errors, e.g., typos, on one hand, but also to reach an agreement on a common vocabulary to name processes and document types on the other hand 1604, 1606, 1608, 1610. Indeed, as the workshop participants essentially label their documents independently, and as they may work in different departments and have different views on the processes they are involved in, they may use a different vocabulary to denote the same document types and processes.

To address these issues, the system analyses the words or text used by the participants. It uses fuzzy matching to regroup similar words in order to cover possible typos in the labels specified by the participants. It may furthermore use linguistic and/or domain specific tools to check for synonyms or expressions conveying the same or similar meaning. It also checks if document sets that are visually very similar have been labeled with different document type labels by different participants, or if the same label has been used for very different document sets. All these situations indicate potential labelling issues. Finally, the system identifies cases where similar document sets have been labeled with the same process and document type but with different print reasons: a typical confusion occurs often with respect to the archive and distribute print reasons. The system will flag all these cases so that they may be considered and discussed by the participants collectively and collaboratively in the requalification phase.

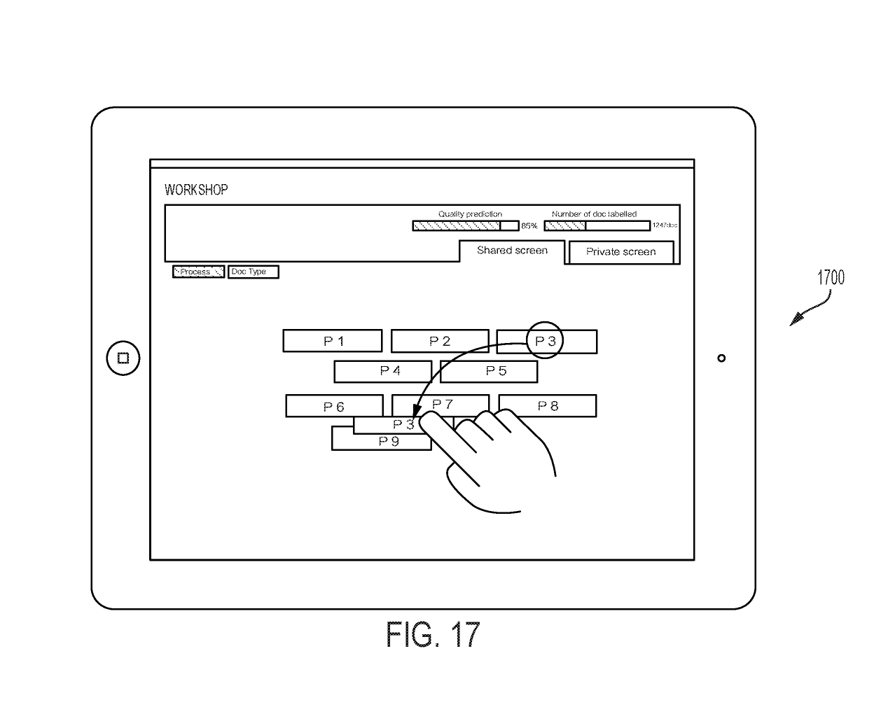

With reference to FIG. 17, the workshop consultant mediates this discussion around the large display going through the different detected problematic cases. According to the detected problem and the discussion, the labels given to denote processes or document types can be reconsidered, and/or the corresponding document sets can be split and/or merged 1700.

Propagation Phase

With respect to FIG. 18, in the propagation phase, the system uses the labeled document sets resulting from the previous phases to train classifiers that will automatically classify 1802 new documents into these sets, i.e., into the association of a print reason, a process and a document type. Since the print reason is determined by the process and the document type, the system only needs to train classifiers able to identify those two values to assign a document to the right document set. Both values are closely correlated to the document content, the document type to the visual content and the process to the textual content of the document.

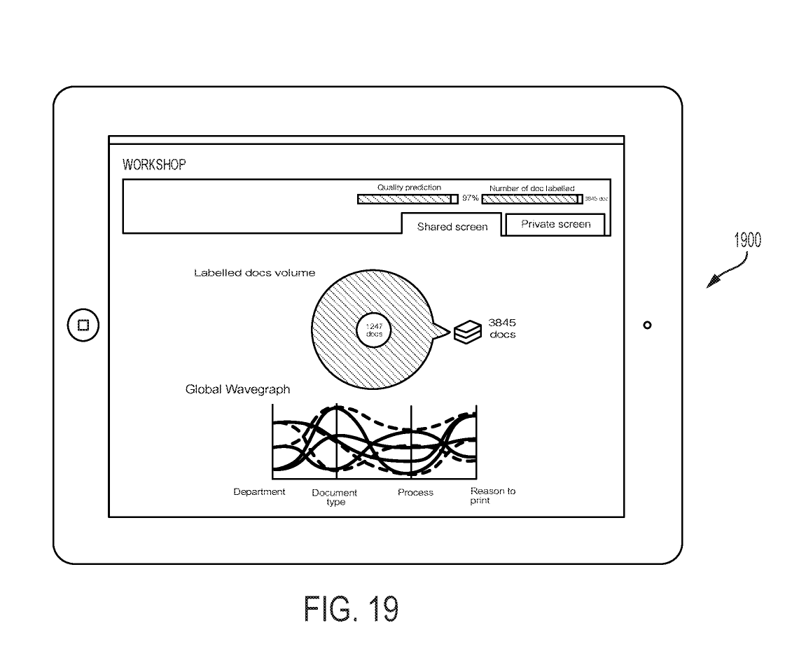

The system then applies the resulting classifiers to all the remaining (un-labeled) documents from the tracking period. As a result it highlights the proportion of documents that can be classified with sufficient confidence 1804, 1806, 1808. The system may use different ways to evaluate this confidence, e.g., entropy, a fixed confidence threshold etc. The proportion of documents classified with sufficient confidence directly represents the impact that the participants' labeling effort has on the global print volume, see FIG. 19.

To motivate and reward the participants for their contribution, the facilitator introduces the propagation effect and invites participants to gather around the main screen where the propagation effect is shown through a visual animation highlighting the effect of a small set of labelled document on the global mass of documents. This illustrates the impact of the work done by all the participants.

Discussion of selected processes.

With reference to FIG. 20, the workshop terminates with a final discussion of the identified processes and their use of paper. One possibility to approach this discussion is to display the corresponding wave graph 2002 representing these processes together with their paper usage on the large display. This wave graph, shows who (in terms of departments) is printing in which context (in terms of process) and for which reason (in terms of reason to print). Each line in the wave graph corresponds to one of the document sets identified by the participants and directly represents the volume of paper it consumes.

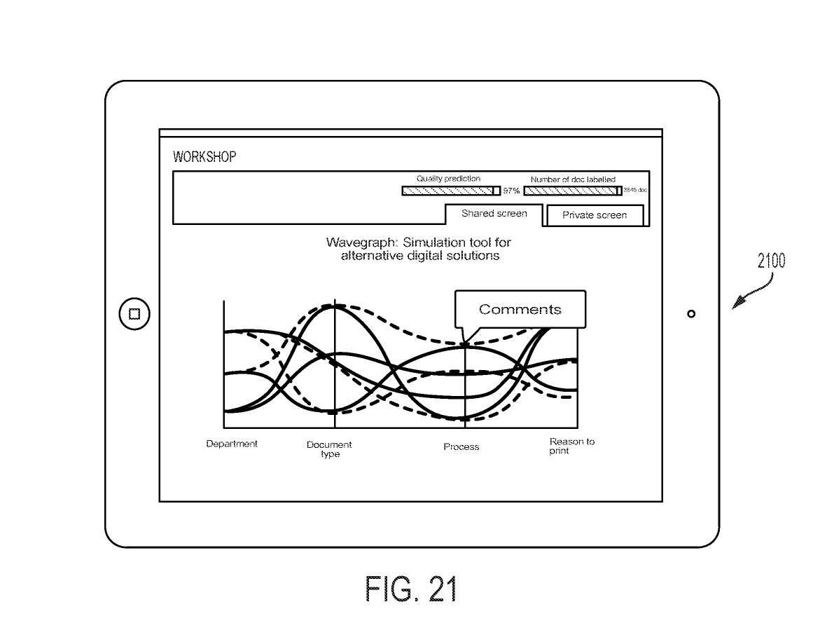

By selecting specific points or lines in the graph, the facilitator can focus the discussion with the participants on concrete paper consumption aspects. The aim of this phase is to better understand the different processes and to identify current print reduction barriers and more complex reasons to print. All this information, captured from the people living the process, help to better understand the reality of the process and to anticipate directions for paperless alternatives 2004. See also FIG. 21.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method for gathering knowledge related to paper-intensive processes associated with one or more printing systems used in an organization to generate printed documents by a group of users, the method comprising:
a) generating a representative set of printed documents by tracking and storing all or a portion of the printed documents and associated metadata generated by the printing system over a predetermined duration of time;
b) processing the representative set of printed documents to generate a plurality of clusters of printed documents, each cluster of printed documents including a subset of the representational set of printed documents which are associated with a predefined measurement of similarity;
c) assigning a set of users to label each cluster of printed documents, each set of users including a subset of users selected from the group of users and each subset of users associated with a relatively high degree of contribution to the cluster of printed documents, relative to other users, included in the group of users;
d) receiving document labeling data from the subsets of users for one or more printed documents associated with each of the respective document clusters, the labeling data including one or more of a process type, a document type and a reason for printing the printed document;
e) training a classifier using all or part of the received document labeling data and associated printed documents;
f) using the trained classifier, classifying one or more printed documents generated in step a) which were not included in the plurality of clusters of printed documents generated in step b);
g) compiling the label data for all or a portion of the representative set of printed documents, including label data directly provided by one or more users and label data provided in step f); and
h) generating one or more indicators representing the use of printed documents associated with one or more of the document type, the process, the user, a project and the reason for printing.

2. The computer-implemented method for gathering knowledge related to paper-intensive processes according to claim 1, wherein generating a representative set of printed documents further includes selecting an optimal set of documents from the printed documents and associated metadata stored over a predetermined amount of time.

3. The computer-implemented method for gathering knowledge related to paper-intensive processes according to claim 1, wherein the representative set of printed documents is re-processed to generate an updated plurality of clusters of printed documents.

4. The computer-implemented method for gathering knowledge related to paper-intensive processes according to claim 1, wherein receiving document labeling data further includes analyzing the labels and applying fuzzy logic to group together similar labels.

5. The computer-implemented method for gathering knowledge related to paper-intensive processes according to claim 1, wherein training a classifier classifies new documents into a print reason, a process, or a document type classification.

6. The computer-implemented method for gathering knowledge related to paper-intensive processes according to claim 5, wherein training a classifier further includes training classifiers to identify only the process and document type to assign a document to the correct document cluster.

7. The computer-implemented method for gathering knowledge related to paper-intensive processes according to claim 1, wherein generating one or more indicators highlights the proportion of documents classified with sufficient confidence including entropy, or a fixed confidence threshold.

8. The computer-implemented method for gathering knowledge related to paper-intensive processes according to claim 1, wherein generating one or more indicators includes generating a wave graph representing the overall process completion.

9. A computer program product comprising a non-transitory recording medium storing instructions which, when executed by a computer processor, perform the method of claim 1.

10. A system comprising memory which stores instructions for performing the method of claim 1 and a processor in communication with the memory which implements the instructions.

11. A system for gathering knowledge related to paper-intensive processes associated with one or more printing systems used in an organization to generate printed documents by a group of users, the system comprising:
a print job tracking component configured to generate a representative set of printed documents by tracking and storing all or a portion of the printed documents and associated metadata generated by the printing system over a predetermined duration of time;
a clustering component configured to process the representative set of printed documents to generate a plurality of clusters of printed documents, each cluster of printed documents including a subset of the representational set of printed documents which are associated with a predefined measurement of similarity;
an annotation component configured to assign a set of users to label each cluster of printed documents, each set of users including a subset of users selected from the group of users and each subset of users associated with a relatively high degree of contribution to the cluster of printed documents, relative to other users, included in the group of users, and receive document labeling data from the subsets of users for one or more printed documents associated with each of the respective document clusters, the labeling data including one or more of a process type, a document type and a reason for printing the printed document;
a classifier component configured to be trained using all or part of the received document labeling data and associated printed documents and classify one or more of the printed documents generated by the print job tracking component which were not included in the plurality of clusters of printed documents generated by the clustering component;
a compiler configured to compile the label data for all or a portion of the representative set of printed documents, including label data directly provided by one or more users and label data provided by the classifier component; and
an indicator generation component configured to generate one or more indicators representing the use of printed documents associated with one or more of the document type, the process, the user, a project and the reason for printing.

12. The system for gathering knowledge related to paper-intensive processors according to claim 11, wherein the print job tracking component is further configured to select an optimal set of documents from the printed documents and associated metadata stored over a predetermined amount of time.

13. The system for gathering knowledge related to paper-intensive processors according to claim 11, wherein the representative set of printed documents is re-processed to generate an updated plurality of clusters of printed documents.

14. The system for gathering knowledge related to paper-intensive processors according to claim 11, wherein the annotation component is further configured to analyze the labels and apply fuzzy logic to group together similar labels.

15. The system for gathering knowledge related to paper-intensive processors according to claim 13, wherein the annotation component is further configured to regroup each subset of users based upon the re-processed plurality of clusters.

16. The system for gathering knowledge related to paper-intensive processors according to claim 11, wherein the classifier component classifies new documents into a print reason, a process, or a document type classification and trains the classifiers to identify only the process and document type to assign a document to the correct document cluster.

17. The system for gathering knowledge related to paper-intensive processors according to claim 11, wherein the indicator generation component highlights the proportion of documents classified with sufficient confidence including entropy, or a fixed confidence threshold.

18. The system for gathering knowledge related to paper-intensive processors according to claim 11, wherein the indicator generation component generates a wave graph representing the overall process completion for discussion among users.

19. A computer program product comprising a non-transitory recording medium storing instructions which, when executed by a computer processor, perform a method for gathering knowledge related to paper-intensive processes associated with one or more printing systems used in an organization to generate printed documents by a group of users, the method comprising:
a) generating a representative set of printed documents by tracking and storing all or a portion of the printed documents and associated metadata generated by the printing system over a predetermined duration of time;
b) processing the representative set of printed documents to generate a plurality of clusters of printed documents, each cluster of printed documents including a subset of the representational set of printed documents which are associated with a predefined measurement of similarity;
c) assigning a set of users to label each cluster of printed documents, each set of users including a subset of users selected from the group of users and each subset of users associated with a relatively high degree of contribution to the cluster of printed documents, relative to other users, included in the group of users;
d) receiving document labeling data from the subsets of users for one or more printed documents associated with each of the respective document clusters, the labeling data including one or more of a process type, a document type and a reason for printing the printed document;
e) training a classifier using all or part of the received document labeling data and associated printed documents;
f) using the trained classifier, classifying one or more printed documents generated in step a) which were not included in the plurality of clusters of printed documents generated in step b);
g) compiling the label data for all or a portion of the representative set of printed documents, including label data directly provided by one or more users and label data provided in step f); and
h) generating one or more indicators representing the use of printed documents associated with one or more of the document type, the process, the user, a project and the reason for printing.

20. The computer program product according to claim 19, wherein training a classifier classifies new documents into a print reason, a process, or a document type classification and trains the classifiers to identify only the process and document type to assign a document to the correct document cluster.

21. The computer program product according to claim 19, wherein generating one or more indicators highlights the proportion of documents classified with sufficient confidence including entropy, or a fixed confidence threshold.
